(19) United States
(12) Patent Application Publication
(10) Pub. No.: US 2024/0304883 A1
(43) Pub. Date: Sep. 12, 2024

(54) LITHIUM RECYCLING

(71) Applicant: Ascend Elements, Inc., Westborough, MA (US)

(72) Inventors: Kee-Chan Kim, Westborough, MA (US); Eric Gratz, Westborough, MA (US); Benoit Tranape, Westborough, MA (US)

(21) Appl. No.: 18/598,887

(22) Filed: Mar. 7, 2024

Related U.S. Application Data
(60) Provisional application No. 63/451,424, filed on Mar. 10, 2023.

(51) Int. Cl. H01M 10/54; B01D 61/02; B01D 61/04; B09B 3/70; B09B 3/80; C01D 15/02; C01D 15/08; C01G 53/00; C01G 53/10; B09B 101/16

(52) U.S. Cl. CPC H01M 10/54; B01D 61/027; B01D 61/04; B09B 3/70; B09B 3/80; C01D 15/02; C01D 15/08; C01G 53/003; C01G 53/10; B09B 2101/16

(57) ABSTRACT

A recycling method for generating purified lithium salts from a recycling stream of lithium-ion (Li-ion) batteries includes leaching black mass from the recycling stream in an aqueous solution of an oxidizing agent. Delithiated black mass is filtered from the aqueous solution to generate a Li-rich leach solution, which is subjected to nanofiltration to form a nanofiltration permeate from which the purified lithium salt is obtained.

### RELATED APPLICATIONS

This patent application claims the benefit under 35 U.S.C. § 119(e) of U.S. Provisional Patent App. No. 63/451,424, filed Mar. 10, 2023, entitled “LITHIUM RECYCLING,” incorporated herein by reference in entirety.

### BACKGROUND

Lithium-ion (Li-ion) batteries are a preferred chemistry for secondary (rechargeable) batteries in high discharge applications such as electrical vehicles (EVs) and power tools where electric motors are called upon for rapid acceleration. Li-ion batteries include a charge material, conductive powder and binder applied to or deposited on a current collector, typically a planar sheet of copper or aluminum. The charge material includes anode material, typically graphite or carbon, and cathode material, which includes a predetermined ratio of metals such as lithium, nickel, manganese, cobalt, aluminum, iron and phosphorous, defining a so-called “battery chemistry” of the Li-ion cells.

### SUMMARY

A method of generating a purified lithium (Li) salt from a recycling stream of lithium-ion (Li-ion) batteries includes leaching black mass from the recycling stream in an aqueous solution of an oxidizing agent, filtering delithiated black mass from the aqueous solution to generate a leach solution, subjecting the leach solution to nanofiltration (NF) to form a nanofiltration permeate and a nanofiltration concentrate, and obtaining the purified lithium salt from the nanofiltration permeate. The oxidizing agent can be, for example, a persulfate or a chlorate and is preferably an ammonium salt such as ammonium persulfate (APS). Nanofiltration may be applied iteratively to aggregate the Li yield. In an example configuration, ultrafiltration on the Li leach solution may precede nanofiltration to remove suspended sub-micron particles. The NF permeate can be further purified, such as with an ion exchange (IX) resin to yield a solution that is at least 99% lithium sulfate.

Depicted further below is an example method and approach for recycling batteries such as Li-ion batteries, often from a recycling stream of multiple battery chemistries including nickel, manganese, cobalt and aluminum in various ratios. In general, modern secondary (rechargeable) batteries employ metals such as Ni, Mn, Co and Al in various ratios as a cathode material, along with a binder and conductive material, and graphite or similar forms of carbon as an anode material. Recycling is typically commenced with discharging and physical dismantling, crushing, and/or agitating the battery structure to yield a granular, comingled stock referred to as “black mass,” including cathode, anode, and various casing and conductor materials. Retired or defective electric vehicle (EV) batteries are often sought for their large volume of raw charge materials for recycling.

Configurations herein are based, in part, that regardless of the charge material metals prescribed by the battery chemistries, such batteries are a viable source of lithium metal for use in recycled batteries. In general, the black mass can be recycled into constituent component metal salts by various leaching, pH adjustment, heating and coprecipitation steps. Conventional approaches to Li-ion battery recycling utilize sodium-based reagents during leaching steps and are often directed to recycling the transition metals over Li. Unfortunately, when recycling Li, these conventional approaches suffer from the shortcoming that sodium salts are particularly difficult to separate from Li salts, and the recycling yield of Li tends to contain Na contaminants. Sodium ions are difficult to separate from Li ions in subsequent attempts to extract pure Li. Accordingly, configurations herein substantially overcome the shortcomings of conventional Li recycling to recover a highly purified Li by combining various purification/isolation techniques in combination with the use of an ammonium salt as an oxidation agent for avoiding the Na+/Li+ separation issue.

In a particular configuration, a method of generating a purified lithium salt from a recycling stream of lithium-ion (Li-ion) batteries such as NMC (Ni, Mn, Co) batteries includes leaching black mass from the recycling stream in an aqueous solution of an oxidizing agent, such as by stirring and heating above 60° C. for 2-8 hours, and filtering delithiated black mass from the aqueous solution to generate a leach solution that is subjected to nanofiltration. The purified lithium salt is obtained from the permeate of the nanofiltration.

### BRIEF DESCRIPTION OF THE DRAWINGS

The foregoing and other features will be apparent from the following description of particular embodiments disclosed herein, as illustrated in the accompanying drawings in which like reference characters refer to the same parts throughout the different views.

The drawings are not necessarily to scale, emphasis instead being placed upon illustrating the principles of the invention.

FIG. 1 is a flowchart of Li recycling as disclosed herein;

FIG. 2 shows the effect of the oxidizing agent (APS) ratio on Li leaching selectivity;

FIG. 3 shows the effect of temperature on Li leaching selectivity; and

FIG. 4 shows the effect of reaction time on Li leaching selectivity.

### DETAILED DESCRIPTION

Depicted below is an example method and approach for generating lithium salts from the recycling of Li-ion batteries, often from a recycling stream of multiple battery chemistries including nickel, manganese, cobalt and aluminum in various ratios. In general, modern secondary (rechargeable) batteries employ metals such as Ni, Mn, Co and Al as a cathode material, along with a binder and conductive material, and graphite or similar forms of carbon as an anode material. Recycling is typically commenced with discharging and physical dismantling, crushing, and/or agitating the battery casing structure to yield a granular, comingled stock referred to as “black mass,” including cathode, anode, and various casing and conductor materials. Retired or defective electric vehicle (EV) batteries are often sought for their large volume of raw charge materials for recycling.

Recovering lithium from spent LIB is an emerging aspect of battery recycling due to the Li demand increase by Li-Ion battery industries and natural resource limitations. Various methods have been developed for recovering lithium from the spent batteries by hydrometallurgical methods. However, the resulting lithium leach liquors often include high concentrations of sodium and other metal ions due to the sodium-containing chemicals used during the leaching and purification processes. The high sodium content in the lithium leach liquors imposes constraints for isolation of battery grade lithium salts, such as lithium carbonate or hydroxide, due to the coprecipitation with the sodium salts. The sodium ions in the Li leach liquor are very difficult to separate out or remove, and separation is often very costly. Nano-filtration has been known to separate ions based on ionic charge and/or size. For example, monovalent Li⁺ ions can exclusively permeate an NF membrane while divalent ions, such as Ni²⁺, Co²⁺ and Cu²⁺ ions, are mostly rejected by the NF membrane. Furthermore, small Li+ ions are able to pass through an NF membrane while the bulkier NH₄⁺ ions are rejected due to the bulkiness even though they are similarly charged. However, Lit and Na⁺ permeation through NF is not significantly different, and the separation of these by nanofiltration is typically very poor.

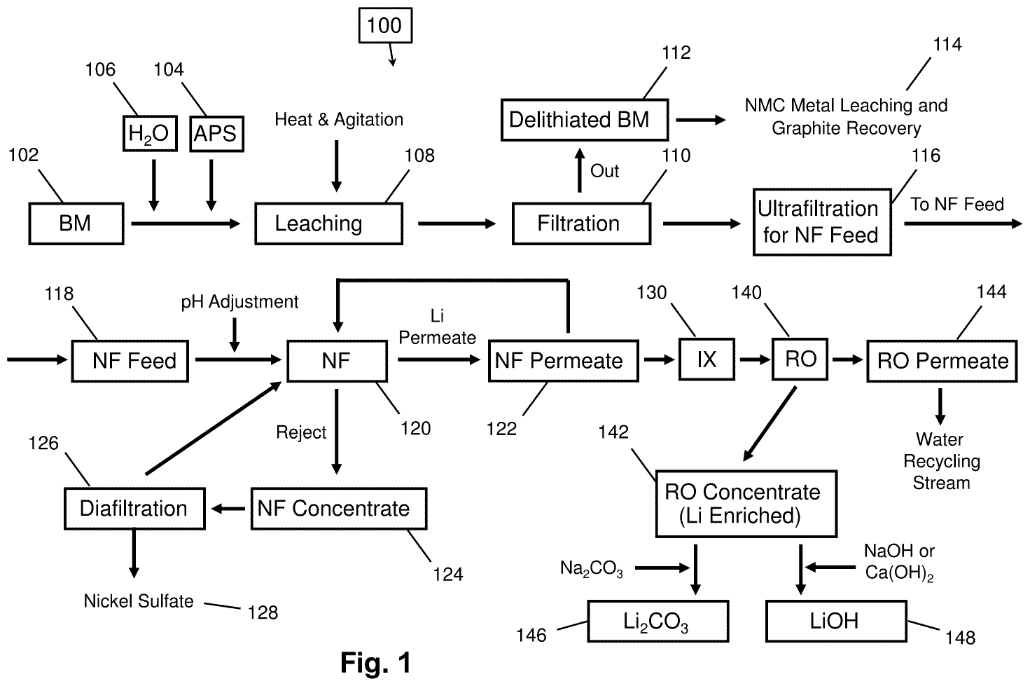

FIG. 1 is a flowchart 100 of a process for producing purified Li salts (about 95% pure) in conjunction with a recycling stream from NMC batteries. Other battery chemistries may be employed, however, providing the oxidizing agent supports a diffusion selectivity with Li. For example, some conventional approaches have suggested ammonium persulfate with iron phosphate-based battery chemistries, but not with NMC.

Configurations herein demonstrate the development of an efficient method for early-stage lithium recovery during the Li-ion battery recycling and solve the problem of high sodium impurity in the Li leach liquor, which is commonly encountered in lithium recovering processes that include leaching of Li-ion battery materials.

Referring to FIG. 1, in an example NMC recycling stream, the disclosed approach produces purified lithium (Li) salts from a recycling stream of lithium-ion (Li-ion) batteries and includes leaching a black mass 102 from the recycling stream in an aqueous solution of an oxidizing agent. No leach acid is required, and an acid for this leach of black mass is preferably avoided.

In an example configuration, lithium in the ternary NMC metal oxide, Li[NiₓMn_{y}Co_{z}]O₂ (wherein x, y, and z represent the molar ratio of Ni, Mn, and Co respectively) of the cathode material from spent batteries is leached with high Li selectivity using an oxidizing agent such as a persulfate or chlorate oxidizing agent, in water. As a specific example, the leaching agent is ammonium persulfate 104 (APS, [NH₄]₂S₂O₈) in water 106. In some configurations, leaching conditions include stirring and heating at a temperature above 60° C. for 2-8 hours, although leach time and temperature can be modified as needed. In general, the oxidizing agent can be selected based on a selectivity for leaching Li and in case of removing after leaching, such as by nanofiltration. The use of persulfates or chlorates as an oxidizing agent demonstrates a high selectivity for Li leaching, and APS, in particular, avoids the introduction of sodium ions into the Li recycling stream. These are also compatible with further downstream recycling of the NMC cathode material from black mass 102.

Thus, the approach shown in FIG. 1 demonstrates a high selectivity for Li leaching in water from the spent NMC Li-Ion batteries using oxidizing agents such as persulfates and chlorates. Instead of the conventional use of sodium salts of the oxidizing agent, configurations herein employ the ammonium salt of the oxidizing agents for avoiding the Na+/Li+ separation problems, particularly those associated with NF technology for the recovery of the lithium by conversion to lithium salts such as lithium carbonate or lithium hydroxide. Lithium is leached from the NMC black mass as follows:

$$2 Li [ {Ni}_{x} {Mn}_{y} {Co}_{z} ] {O}_{2} ( s ) + {[ {NH}_{4} ]}_{2} [ {S}_{2} {O}_{8} ] ( s ) \to 2 {Li}^{+} ( aq ) + 2 {NH}_{4}^{+} ( aq ) + 2 {SO}_{4}^{2 -} ( aq ) + {Ni}_{x} {Mn}_{y} {Co}_{z} {O}_{2} ( s ) \\ where ( x + y + z = 1 )$$

As noted above, it has been found that the selection of a persulfate or chlorate oxidizing agent can result in substantial selectivity for lithium leaching. In addition, the amount of oxidizing agent has also been found to improve lithium leaching yield. In an example configuration, the amount of ammonium oxidizing agent is selected based on the quantity of Li present in the black mass from the recycling stream, which can be measured or tested by techniques known in the art. As a specific example, ammonium persulfate is used as an oxidizing agent in a molar ratio of 0.45-0.7 to the moles of Li in the black mass. The black mass is typically a highly unordered granular mass from physical agitation and crushing/grinding of exhausted batteries and includes extraneous materials such as casing and current collectors (Cu, Al) in addition to comingled cathode and anode materials. The amount of Li, as well as a ratio of NMC charge materials, may also be ascertained from a controlled source of batteries, but often this is not exacting because controls over the input source to the recycling stream may be limited.

Following leaching at step 108, the resulting leach solution is filtered at step 110 to remove delithiated black mass and to obtain a Li leachate. As shown, delithiated black mass 112 is filtered from the aqueous solution to generate a leach solution for a nanofiltration (NF) feed. This microfiltration removes NMC solids, preferably using a filter size for 1 μm or smaller particles. Subsequent recycling and leaching may occur to recycle the cathode materials of Ni, Mn, and Co as well as anode materials including graphite, as depicted at step 114. This NMC leaching step generally requires the use of an acidic leach solution.

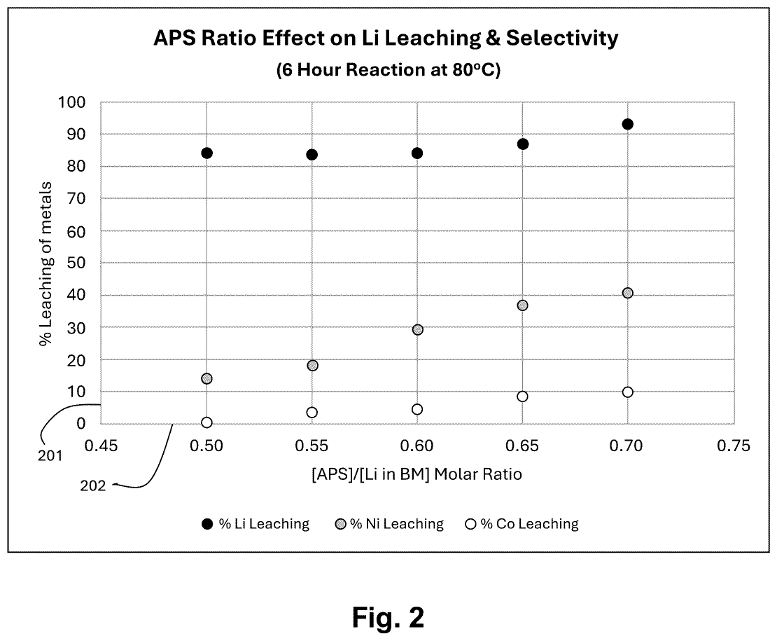

FIGS. 2-4 show results of leaching parameters on Li leaching selectivity and yield. FIG. 2 shows the effect of the molar ratio of oxidizing agent (APS) to lithium present in the black mass ([APS]/[Li in BM]) on metal leaching. As shown, the leach percentage for lithium using APS under these conditions is 85%-95%, indicating a very high leach effectiveness across the molar ratio range, peaking at a molar ratio of approximately 0.70. Ni is leached at much lower amounts of from about 15% to about 40%, also reaching a maximum at a molar ratio of 0.70, while Co leaching was very low with a maximum of about 10%. Thus, APS is very effective for Li-selective leaching.

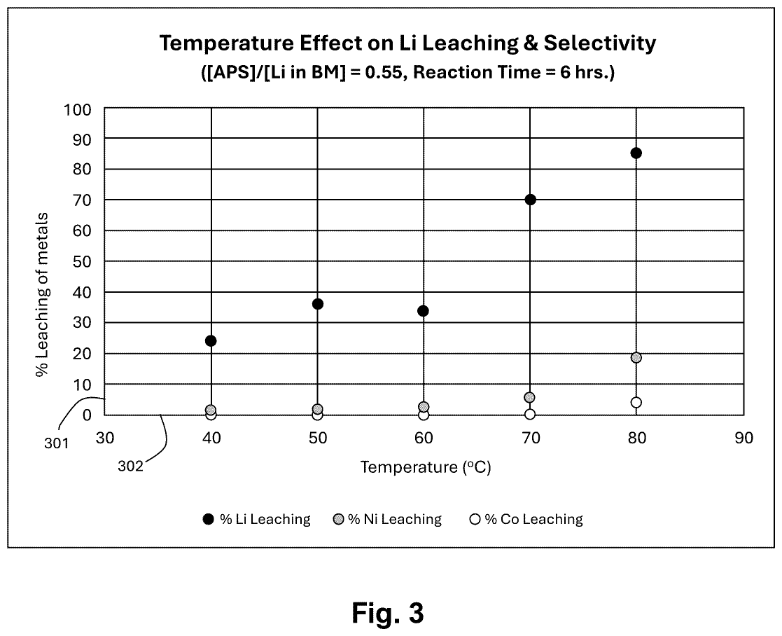

FIG. 3 shows the effect of temperature on Li leaching selectivity. As shown, Li leaching ranges from about 25% to about 85% at a temperature of 80° C. Leached Ni is very low and approaches 20% at 80° C., while Co is rather flat, increasing to a maximum of only about 5% at 80° C.

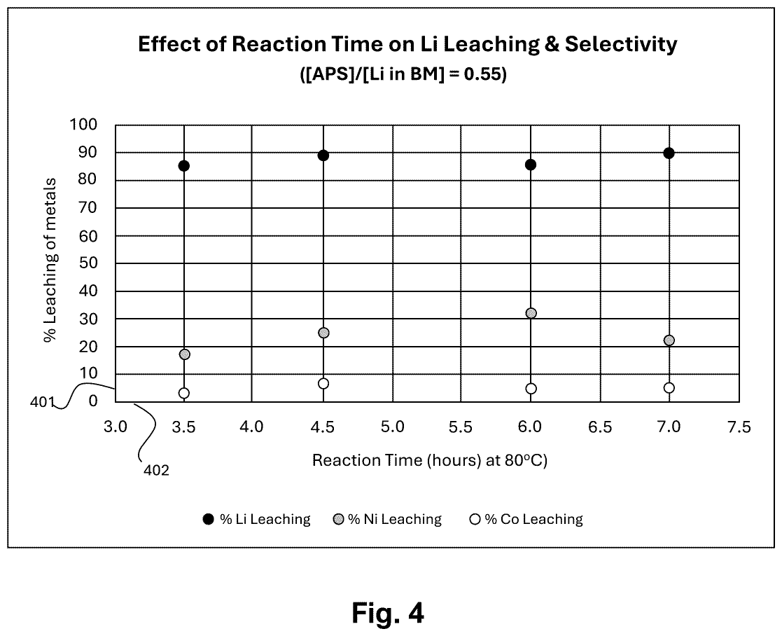

FIG. 4 shows the effect of reaction time on Li leaching selectivity. As shown, Li leaching is very high at times from at least 3.5 hours, achieving nearly 90% overall leaching. Ni leaching is considerably lower, peaking at about 35% at 6.0 hours, and Co remains very low at or below 5% despite duration.

Returning to FIG. 1, as shown, after filtration to remove the delithiated black mass, the resulting Li leach solution is preferably subjected to ultrafiltration (UF) in order to remove remaining suspended sub-micron particles, as depicted at step 116. The filtered leachate is then used as feed 118 for nanofiltration at step 120, in which the leachate passes through a nanofiltration (NF) membrane to remove other metal impurities in the leachate. In some configurations, it may be preferable to lower the pH of the leach solution prior to nanofiltration by the addition of an acid, such as sulfuric acid or the like.

Nanofiltration may be an iterative and/or complementary step for improving purity. For example, when ion concentrations in the leach solution are high, a single nanofiltration step may not be sufficient to remove all the impurity ions. Therefore, an iterative nanofiltration strategy may be applied for concentrating the retentate from the nanofiltration. Accordingly, as shown, NF permeate 122 may undergo a second NF pass. Further, each NF concentrate 124, which include ions rejected by nanofiltration, may contain a low but non-trivial residual Li concentration. This can be recovered as shown by subjecting the NF concentrate to diafiltration to increase the Li concentration, as depicted in step 126, and re-subjecting the concentrate to additional nanofiltrations.

In addition, it has been found that the NF concentrate often includes nickel salts since, as shown in FIGS. 2-4, some Ni can be leached in this process. The leached Ni salts can be recovered from the NF concentrate, as depicted at step 128. For example, a saturated/supersaturated nickel and ammonium sulfate solution can be formed, from which Ni sulfate can be precipitated or crystallized. Thus, Ni salts can be generated from this Ni-enriched solution, as an additional benefit to the process described herein. For example, the resulting nickel sulfate crystalline product, [Niₓ(NH₄)_{2y}]SO₄·z[H₂O] where x+2y=1 and z=1-12, is a useful reagent for precursor synthesis for recycled cathode materials. Specifically, the nickel sulfate can be used to provide the Ni metal salt used for recycled NMC precursor solution and the ammonium in the salt may be used for a chelating agent to the metal ions on the precursor co-precipitation. This crystalline product can be utilized for preparing metal solutions or adjusting the metal concentrations for reentering the NMC recycling stream form step 114 or may be purified to obtain high quality nickel sulfate for various applications.

The NF membrane for nanofiltration is selected based on an ion selectivity of Li over ions introduced by the oxidizing agent; ammonium in the case where APS is employed as the oxidizing agent. Alternate configurations may employ an NF membrane having a selectivity between Li and the oxidizing agent. The present example exhibits passing monovalent ions through an NF membrane selected for receiving the NF feed, while restricting passage of divalent ions. For the particular APS oxidizing agent, the NF membrane is selected for nanofiltration based on a selectivity between Li⁺ ions over NH₄⁺ ions, as follows:

$$2 {Li}^{+} ( aq ) + 2 {NH}_{4}^{+} ( aq ) + 2 {SO}_{4}^{2 -} ( aq ) \to \vert Nanofiltration \vert \to 2 {Li}^{+} ( aq ) + {SO}_{4}^{2 -} ( aq )$$

In a specific configuration, the resulting NF permeate 122 has a breakdown as shown in Table I:

TABLE I
Final NF Permeate Result

| | NF Feed Solution | NF Final Composite |
|---|---|---|
| Element | (mg/L) | Permeate (mg/L) |
| Lithium, Li | 3378 | 1565 |
| Nickel, Ni | 5430 | 72 |
| Cobalt, Co | 129 | 1.4 |
| Copper, Cu | 1172 | 21.4 |
| Aluminum, Al | <1.0 | <1.0 |
| Sodium, Na | 26 | 116 |
| Sulfate, SO4 | 65000 | 11000 |

Thus, the final NF permeate is a highly pure lithium sulfate solution, and the total Li recovery from the NF process is 95% or higher.

Optionally, any residual metal impurities remaining in the final NF permeate can be further removed using an ion exchange (IX) resin, as shown in step 130, to obtain battery grade lithium product (99% or greater purity). At step 140, reverse osmosis (RO) can be applied to the purified Li solution, resulting in a Li solution having a suitable concentration for purified lithium salt recovery. The RO permeate that passes through the RO membrane may also be recycled, as depicted at step 144. Lithium carbonate may be generated from the Li-enriched RO concentrate 142 by adding a reagent such as Na₂CO₃, as shown at step 136. Alternatively, lithium hydroxide may be recovered by adding NaOH, Ca(OH)₂ or Mg(OH)₂, as depicted at step 148.

A specific example use case follows:
1) [APS] and [Li in BM] are combined in molar ratio is between 0.45 and 0.70, preferably 0.5-0.6.
2) H₂O/BM weight ratio is 1-6, preferably 2.
3) Reaction temperature is 60° C.-100° C., preferably 80° C.-95° C.
4) Reaction time is 2-6 hours, preferably 4 hours.
5) Solid removal after the leaching reaction is done by microfiltration (preferably by 1-μm membrane or below) and then ultrafiltration (preferably 0.01 μm membrane or below) to produce the leach solution.
6) The leach solution is acidified with sulfuric acid to a pH=1-3 for better permeation of lithium sulfate (by forming lithium hydrogen sulfate) during nanofiltration, preferably to a pH=1.5-2.5.
7) NF concentrates become saturated/supersaturated nickel and ammonium sulfate solution and [Niₓ(NH₄)_{2y}]SO₄·z[H₂O] salts are crystallized as a secondary useful product.
   In another use case,

50 g of Li-Ion battery black mass (BM) was dispersed in 100 mL of deionized water. APS was added in 0.55 molar ratio per Li in BM. The mixture was heated to approximately 90° C. with a good agitation for 4 hours. Then the delithiated BM was separated out by vacuum filtration with a 1-μm filter paper. The filtrate (Li leach solution) is light green color due to a small percent of Ni that is also leached. The typical Li and Ni concentrations in the leach solution are 0.5-1.2 M Li and 0.09-0.2 M Ni.

TABLE II

| Element | Li | Ni | Mn | Co | Cu | Al | Na | Fe | S | Ca | Mg | Cr | Zn | Zr |
|---|---|---|---|---|---|---|---|---|---|---|---|---|---|---|
| ICP (mg/L) for | 4361 | 6987 | <1 | 344 | 1045 | <1 | 57 | <1 | 24894 | 2 | <1 | <1 | <1 | <1 |
| Leach solution | | | | | | | | | | | | | | |

Impurities including the high concentration (˜ 1.5 M) of ammonium ions in the leach solution was removed by NF after adjusting the leach solution pH=2.5 with sulfuric acid. Rejected lithium ions in the NF concentrate were recovered further via diafiltration. The final NF permeate and the ion-exchanged purification of the NF permeate are pure enough (see Table II above) to recover technical or even battery grade lithium carbonate. Nickel and ammonium sulfate were co-crystallized in the NF concentrate (rejection), which is useful for precursor synthesis of cathode active materials.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method of generating a purified lithium salt from a recycling stream of lithium-ion (Li-ion) batteries comprising:
leaching black mass from the recycling stream in an aqueous solution of an oxidizing agent,
filtering delithiated black mass from the aqueous solution to generate a leach solution,
subjecting the leach solution to nanofiltration to form a nanofiltration permeate and a nanofiltration concentrate, and
obtaining the purified lithium salt from the nanofiltration permeate.

2. The method of claim 1, wherein the oxidizing agent is a persulfate or a chlorate oxidizing agent.

3. The method of claim 1 wherein the oxidizing agent is an ammonium salt oxidizing agent.

4. The method of claim 1, wherein the oxidizing agent is ammonium persulfate (APS).

5. The method of claim 1, wherein the black mass is leached at a temperature of greater than 60° C. for 2-8 hours.

6. The method of claim 1, wherein the purified lithium salt is obtained by:
concentrating the nanofiltration permeate by reverse osmosis to form a concentrated Li solution,
combining the concentrated Li solution and a water-soluble salt to form a purified lithium salt solution, and
obtaining the purified lithium salt from the purified lithium salt solution.

7. The method of claim 6, wherein the water-soluble salt is a carbonate or a hydroxide.

8. The method of claim 7, wherein the water-soluble salt is sodium carbonate, sodium hydroxide, magnesium hydroxide, or calcium hydroxide.

9. The method of claim 6, wherein the purified lithium salt solution comprises at least 95% by weight of the purified lithium salt.

10. The method of claim 6, wherein, prior to concentrating the nanofiltration permeate by reverse osmosis, the nanofiltration permeate is purified using an ion exchange resin.

11. The method of claim 10, wherein the purified lithium salt solution comprises at least 99% by weight of the purified lithium salt.

12. The method of claim 1, wherein a nanofiltration membrane for nanofiltration is selected based on an ion selectivity of Li over ions introduced by the oxidizing agent.

13. The method of claim 1, wherein the black mass comprises Ni, Mn, and Co from NMC batteries in the recycling stream.

14. The method of claim 1 further comprising determining moles of Li in the black mass and wherein the amount of the oxidizing agent is based on the determined moles of Li.

15. The method of claim 14, wherein the oxidizing agent is in a molar ratio of 0.45-0.7 to the moles of Li in the black mass.

16. The method of claim 1 further comprising passing the filtered, delithiated black mass to an NMC recycling process.

17. The method of claim 1 further comprising generating nickel sulfate from the nanofiltration concentrate.

18. The method of claim 1, wherein the leach solution is iteratively subjected to nanofiltration for concentrating the nanofiltration permeate.

19. The method of claim 1 further comprising subjecting the leach solution to ultrafiltration to remove suspended submicron particles prior to nanofiltration.

20. The method of claim 1 further comprising acidifying the leach solution to a pH of less than 4 for nanofiltration.
